(19) United States
(12) Patent Application Publication
(10) Pub. No.: US 2015/0362954 A1
(43) Pub. Date: Dec. 17, 2015

(54) METHODS AND DEVICES FOR PROTECTING A COMPUTING DEVICE

(71) Applicants: MEIR ZOHAR, GIV'AT SHMUEL (IL); ZEEV ZOHAR, HERZLIYA (IL); NOAM KRONMAN, REHOVOT (IL)

(72) Inventors: MEIR ZOHAR, GIV'AT SHMUEL (IL); ZEEV ZOHAR, HERZLIYA (IL); NOAM KRONMAN, REHOVOT (IL)

(21) Appl. No.: 14/738,960

(22) Filed: Jun. 15, 2015

Related U.S. Application Data
(60) Provisional application No. 62/012,994, filed on Jun. 17, 2014.

(51) Int. Cl. G06F 1/16; F16M 13/02; F16L 3/015

(52) U.S. Cl. CPC G06F 1/1656; F16L 3/015; F16M 13/02; G06F 1/1626

(57) ABSTRACT

A device for mounting a display associated with a computing device onto a vertical surface, the device including a body portion including an opening enabling a user to view a display associated with a computing device, at least one body mounting mechanism, functionally associated with the body portion, for mounting the body portion onto a surface, a wire concealing portion, functionally associated with the body portion and accommodating at least one wire connected to the display, the wire concealing portion including at least one wire mounting mechanism, and at least one flexible portion connecting the body portion to the wire concealing portion.

### CROSS-REFERENCE TO RELATED APPLICATIONS

This application claims the benefit of priority from U.S. Provisional Patent Application No. 62/012,994, filed Jun. 17, 2014, which is incorporated herein by reference in its entirety.

### BACKGROUND

Various computing devices, such as tablet computers, smart mobile telephones, and the like, are increasingly used in sub-optimal environments in which the device may become damaged, such as kitchen environments. For example, users may use a computing device in the kitchen to inventory groceries, renew a groceries inventory, search for and view recipes, listen to music while cooking, as well as for various other uses. Naturally, when in a kitchen environment, the computing device may be damaged by spillage, overheating, breakage, and the like.

An additional problem that needs to be addressed is that of power consumption. Most mobile computing devices such as tablet computers and mobile telephones have a relatively short battery life, and cannot be used for extended periods of time without connection to an external power supply.

While some effective solutions for device integrity problems, such as resistance to liquid spillage and to device overheating, have been developed by device manufacturers, the provision of power to the computing device remains problematic. In some cases, the computing devices are plugged into a power source, and placed on the kitchen countertop. However, such placement uses up countertop space, which is often already very limited, making use of the device inconvenient. Additionally, placement of the device on the countertop places the computing device near the heat, liquids, and other hazards to integrity of the device. In other cases, the device is mounted onto a vertical surface, such as a refrigerator or pantry door, thereby economizing kitchen space. One drawback of this solution is that in order to provide power to the vertically mounted computing device, one must draw power lines from the electrical socket, typically in the wall, to the device, resulting in connective wires being carried across the kitchen, which is typically unaesthetic, may interrupt with opening and closing of cabinet doors, and in some cases may also constitute a tripping hazard.

There is thus a need for a method for vertically mounting computing devices in a kitchen environment, while the device is connected to the power supply, such that the functionality and aesthetic feel of the kitchen are not disrupted.

### SUMMARY

The invention, in some embodiments, relates to the field of protecting electronic devices in harsh environments, and more particularly to methods and devices for aesthetically mounting electronic devices including a display in problematic environments.

Some embodiments of the invention relate to methods and devices for aesthetically mounting electronic devices including a display in problematic environments.

Thus, in accordance with one aspect of an embodiment of the teachings herein, there is provided a device for mounting a display associated with a computing device onto a vertical surface, the device including a body portion including an opening enabling a user to view a display associated with a computing device, at least one body mounting mechanism, functionally associated with the body portion, for mounting the body portion onto a surface, a wire concealing portion, functionally associated with the body portion and accommodating at least one wire connected to the display, the wire concealing portion including at least one wire mounting mechanism, and at least one flexible portion connecting the body portion to the wire concealing portion.

In some embodiments, the at least one flexible portion forms part of the wire concealing portion, and the at least one wire mounting mechanism is not located on the at least one flexible portion of the wire concealing portion.

In some embodiments, the opening is formed on a first surface of the body portion, and the at least one body mounting mechanism is attached to a second surface of the body portion, opposing the first surface.

In some embodiments, the body portion, the at least one flexible portion, and the wire concealing portion are integrally formed. In other embodiments, the body portion and the wire concealing portion include two separate portions. In some such embodiments, the body portion and the wire concealing portion are connected by a connecting mechanism, the connecting mechanism including the at least one flexible portion.

In some embodiments, the at least one wire includes a power cable providing power to the display. In some embodiments, the at least one wire includes a wire connecting the display to the computing device associated therewith.

In some embodiments, the display comprises a computing device.

In some embodiments, the at least one flexible portion includes at least one notch adapted to enable the at least one flexible portion to lie adjacent to a corner between the vertical surface and another surface.

In some embodiments, the vertical surface includes a first vertical surface hingedly connected to a second vertical surface, such that in a first orientation the first and second surfaces are angled with respect to one another to form a corner and in a second orientation the first and second surfaces are aligned with one another, and the body portion is adapted to be mounted onto the first surface, and the wire concealing portion is adapted to be mounted onto the second surface, and the at least one flexible portion is adapted to be mounted about the corner, such that when the first and second surfaces are in the first orientation, the flexible portion engages the first and second surfaces along the corner, and when the first and second vertical surfaces are in the second orientation, the flexible portion disengages the first and second surfaces adjacent a hinge connecting the first and second surfaces.

In some embodiments, the first surface includes a door and the second surface includes a side surface hinged to the door, such that in the first orientation the door is closed, and in the second orientation the door is open. In some such embodiments, the flexible portion includes at least one notch adapted to enable the wire concealing portion to engage the corner.

In some embodiments, the body portion includes an insertion opening, separate from the opening, for inserting the display into the body portion.

In accordance with another aspect of an embodiment of the teaching herein, there is provided a method of mounting a display associated with a computing device on a vertical surface, the method including providing a mounting device including a body portion, a wire concealing portion, and at least one flexible portion disposed therebetween, the mounting device including at least one body mounting mechanism and at least one wire mounting mechanism, placing the display in the body portion of the mounting device, such that the display is visible through an opening in the body portion, threading a wire associated with the display through the wire concealing portion, and using at least one of the at least one body mounting mechanism and the at least one wire mounting mechanism, mounting the mounting device having the display and the wire disposed therein onto the vertical surface.

In some embodiments, the vertical surface includes a first vertical surface hingedly connected to a second vertical surface, such that in a first orientation the first and second surfaces are angled with respect to one another to form a corner and in a second orientation the first and second surfaces are aligned with one another and the mounting device includes mounting the body portion onto the first surface, and mounting the wire concealing portion onto the second surface, such that the at least one flexible portion extends about the corner.

In some embodiments, when the first and second surfaces are in the first orientation, the flexible portion engages the first and second surfaces along the corner, and when the first and second vertical surfaces are in the second orientation, the flexible portion disengages the first and second surfaces adjacent a hinge connecting the first and second surfaces.

In some embodiments, the providing includes providing the mounting device such that the flexible portion includes at least one notch, and the mounting includes mounting the flexible portion such that the notch engages the corner.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

Embodiments of methods and/or devices of the invention may involve performing or completing selected tasks manually, automatically, or a combination thereof. Some embodiments of the invention are implemented with the use of components that comprise hardware, software, firmware or combinations thereof. In some embodiments, some components are general-purpose components such as general purpose computers or oscilloscopes. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

### BRIEF DESCRIPTION OF THE DRAWINGS

Some embodiments of the invention are described herein with reference to the accompanying drawings. The description, together with the drawings, makes apparent to a person having ordinary skill in the art how some embodiments of the invention may be practiced. The drawings are for the purpose of illustrative discussion and no attempt is made to show structural details of an embodiment in more detail than is necessary for a fundamental understanding of the invention. For the sake of clarity, some objects depicted in the drawings are not to scale.

In the drawings:

FIGS. 1A and 1B are a schematic planar front view illustration and a schematic planar rear view illustration of an embodiment of a unitary device for mounting a display onto a vertical surface according to an embodiment of the teachings herein;

FIGS. 2A and 2B are a schematic planar front view illustration and a schematic planar rear view illustration of an embodiment of a two-part device for mounting a display onto a vertical surface according to another embodiment of the teachings herein;

FIG. 3 is a schematic pictorial illustration of an embodiment of a unitary device for mounting a display onto a vertical surface adjacent a vertical corner according to yet another embodiment of the teachings herein, the device having a display disposed therein;

FIGS. 4A and 4B, are schematic illustrations of the device of FIGS. 1A and 1B, when mounted onto a hinged door according to an embodiment of the teachings herein, the door being in closed and open positions, respectively; and

FIG. 5 is a schematic illustration of the device of FIGS. 1A and 1B, when mounted onto a hinged door according to another embodiment of the teachings herein.

### DETAILED DESCRIPTION

The invention, in some embodiments, relates to the field of protecting electronic devices in harsh environments, and more particularly to methods and devices for aesthetically mounting electronic devices including a display in problematic environments.

Specifically, some embodiments of the invention relate to a display protector and wire concealer, suitable to be mounted on a vertical device.

The principles, uses and implementations of the teachings herein may be better understood with reference to the accompanying description and drawings. Upon perusal of the description and drawings present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

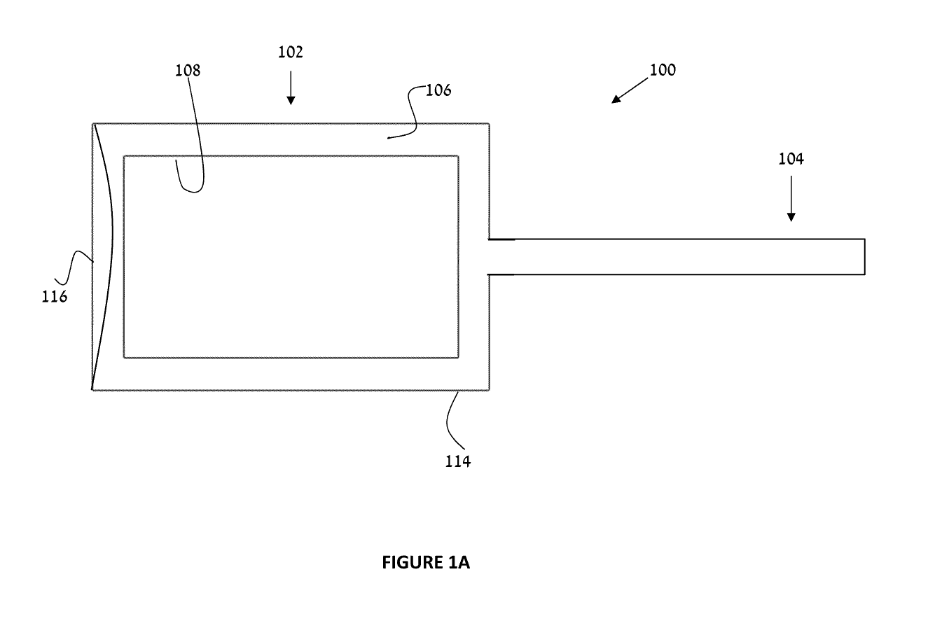

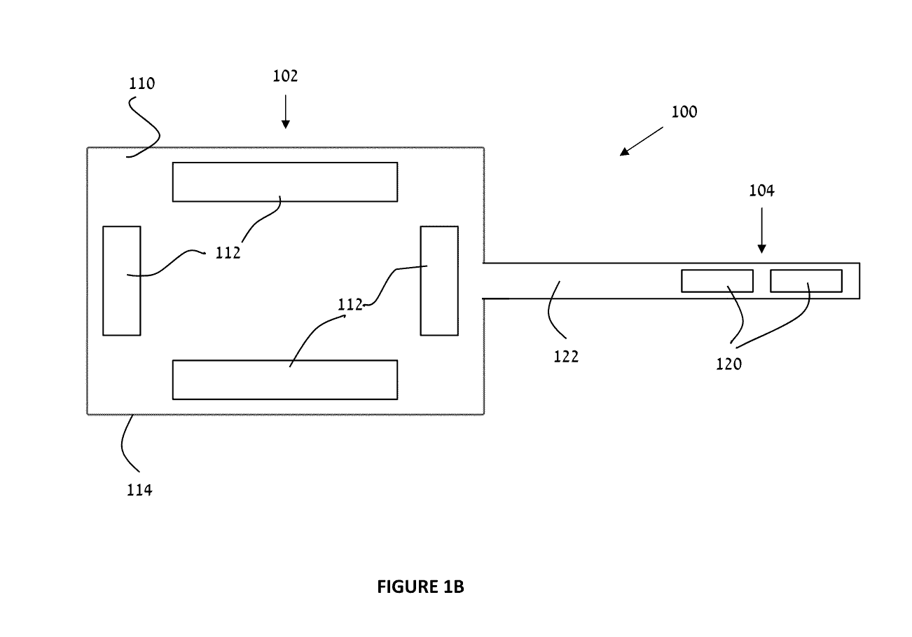

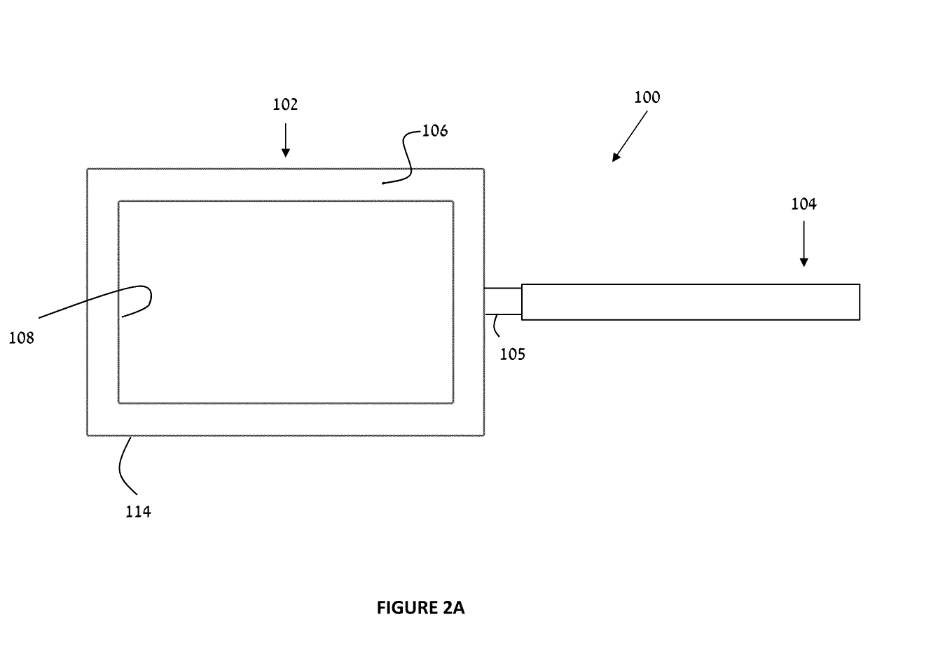

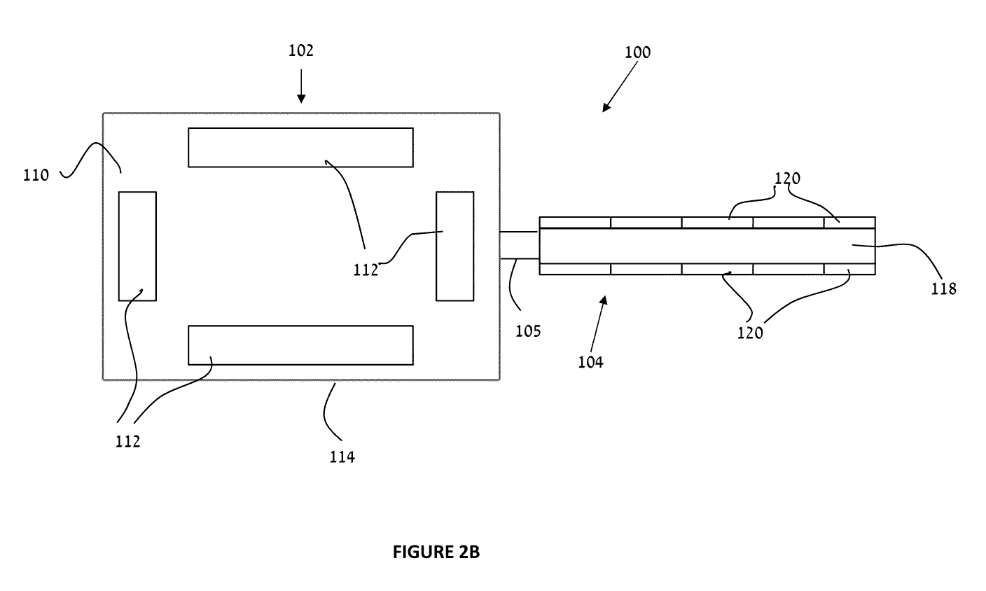

Reference is now made to FIGS. 1A and 1B, which are a schematic planar front view illustration and a schematic planar rear view illustration of an embodiment of a unitary device for mounting a display onto a vertical surface according to an embodiment of the teachings herein, and to FIGS. 2A and 2B, which are a schematic planar front view illustration and a schematic planar rear view illustration of an embodiment of a two-part device for mounting a display onto a vertical surface according to another embodiment of the teachings herein.

As seen, a mounting device 100 according to the teachings herein includes a body portion 102 and a wire concealing portion 104. In the embodiment of FIGS. 1A and 1B, wire concealing portion 104 is integrally formed with body portion 102, whereas in the embodiment of FIGS. 2A and 2B, the wire concealing portion 104 is separate from the body portion 102, and is connected to the body portion using suitable connecting and/or concealing means 105. The connecting or concealing means 105 may be formed of any suitable material that will conceal wires exiting a computing device disposed in body portion 102 until they are concealed by wire concealing portion 104.

Body portion 102 includes a first surface 106, which, in use, is located at the front of the device 100 and is visible by a user. The surface 106 defines a frame surrounding a display opening 108, enabling the user to view a display disposed within the device 100, the display being associated with a computing device. In some embodiments, display opening 108 is merely an area cut out of body portion 102. In other embodiments, the display opening 108 includes a transparent protective surface, such as a glass surface, Plexiglas surface, and the like, such that a computing device disposed within body portion 102 is visible to the user but is protected from the environment. Disposed opposite surface 106 is a second surface 110, which, in use, is located at the rear of the device 100 adjacent a surface onto which the device 100 is mounted. The second surface 110 includes at least one body mounting mechanism 112, such as a magnet, suction cups, adhesive tape, and the like, for mounting the body portion 102 onto a vertical surface. In some embodiments, the entire surface 110 may comprise a body mounting mechanism, such as a magnet or adhesive material covering the whole surface.

Since magnets can attract suitable surfaces even when not directly engaging these surfaces, in embodiments in which the body mounting mechanism 112 comprises magnets, the magnets need not necessarily be mounted on the side of surface 110 which engages the vertical surface on which device 100 is mounted. Thus, the magnets forming body mounting mechanism 112 may be mounted on the exterior of second surface 110 as shown, but may also be mounted on an interior of second surface 110 adjacent a computing device disposed in body portion 102, embedded in surface 110, or mounted onto a surface of the computing device adjacent surface 110 and bonding to the vertical surface through the material of surface 110.

The first surface 106 and the second surface 110 are connected by side surfaces 114.

Body portion 102 may be formed of any suitable material. In some embodiments, the body portion 102 is formed of a rigid material, such as plastic, metal, wood or any other suitable material. In some such embodiments, body portion 102 further includes an insertion opening 116, adapted for insertion of a display to be mounted within device 100, as shown in FIG. 1A. The insertion opening may be located in any suitable location of the device 100, including on a side thereof distant from the wire concealing portion as shown in FIG. 1A, on a top side of the device, on a bottom side of the device, or on a side of the device adjacent, or including, the wire concealing portion 104. In some embodiments, the insertion opening is disposed within surface 110 of device 100, between body mounting mechanisms 112, or in any other location in or on surface 110 or frame 106.

In other embodiments, the body portion 102 is formed of a flexible material, such as silicone, leather, rubber or any other suitable material. In some such embodiments, the user may insert the display into the body portion 102 by flexing the material forming the frame of surface 106 to wrap around the display.

Wire concealing portion 104 is configured to accommodate at least one wire associated with a display located within body portion 102. In some embodiments, wire concealing portion 104 is tubular, as shown in FIG. 1B, such that a wire concealed therein is threaded through the wire concealing portion 104 and is covered from all sides thereby. In other embodiments, the wire concealing portion 104 may be partially open and may define a channel 118 for a wire concealed therein, as shown in FIG. 2B. In such embodiments, in use, the partially open side of the wire concealing portion is disposed adjacent a surface, such as a mounting surface, such that the wire disposed within portion 104 is invisible.

The wire concealing portion has mounted on a surface thereof at least one wire mounting mechanism 120, and includes at least one flexible portion 122 that does not have any wire mounting mechanism mounted thereof. In embodiments in which body portion 102 and wire concealing portion 104 are connected by connecting means 105, for example as shown in FIGS. 2A and 2B, the connecting means are flexible and function as the flexible portion. The wire mounting mechanism 120 may be any mounting mechanism, such as a magnet, suction cups, adhesive tape, and the like, suitable for mounting the wire concealing portion 104 onto a vertical surface.

In some embodiments, the flexible portion 122 is formed of a different material than the rest of the wire concealing portion 104. In other embodiments, the entirety of the wire concealing portion 104 is formed of a flexible material, such as silicone, leather, rubber, fabric or any other suitable material. In some such embodiments, parts of the wire concealing portion 104 are stabilized by the wire mounting mechanism 120.

In some embodiments, the exterior of wire concealing portion 104 is decorated so as to appear more aesthetic, or is colored or marked such that it would be camouflaged in the environment in which the device 100 is mounted.

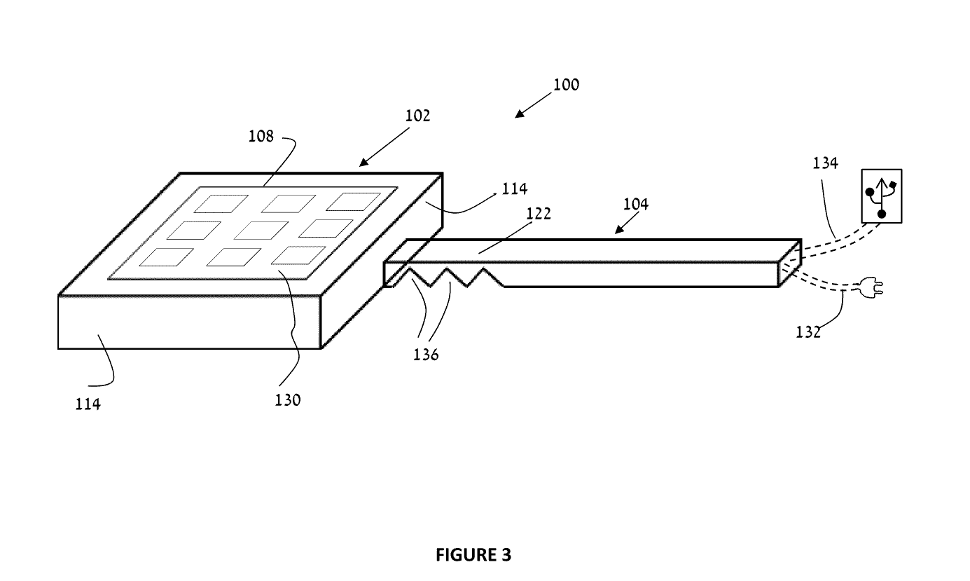

Reference is now made to FIG. 3, which is a schematic pictorial illustration of an embodiment of a unitary device for mounting a display onto a vertical surface adjacent a vertical corner according to yet another embodiment of the teachings herein, the device having a display disposed therein. The illustrated embodiment is similar, in many senses, to the embodiments of FIGS. 1A, 1B, 2A, and 2B, and like parts are labeled with like reference numerals.

As seen in FIG. 3, a display 130 is disposed within body portion 102 of device 100 and is visible through opening 108 thereof. At least one wire associated with display 130, here shown as a power supply wire 132 and a USB connection wire 134, extends through wire concealing portion 104 and is concealed thereby. It is appreciated that wire concealing portion 104 may conceal any type of wire, including a power supply wire, a USB connection cable, an audio output cable, a video output cable, such as a VGA cable, a DVI monitor port, an S-video cable, an RCA connector cable, an HDMI connector cable, a Firewire, a phone cable, an Ethernet cable, or any other suitable wire or cable.

In the embodiment illustrated in FIG. 3, wire concealing portion 104 includes, at a section thereof adjacent body portion 102 and forming part of flexible portion 122, at least one notch 136 formed on a rear surface of the wire concealing portion. The at least one notch 136 is adapted to provide to the wire concealing portion 104 sufficient flexibility to bend around a corner, such as a right angle corner, while remaining adjacent to, and preferably in engagement with, the vertical surfaces defining the corner, as explained in further detail hereinbelow.

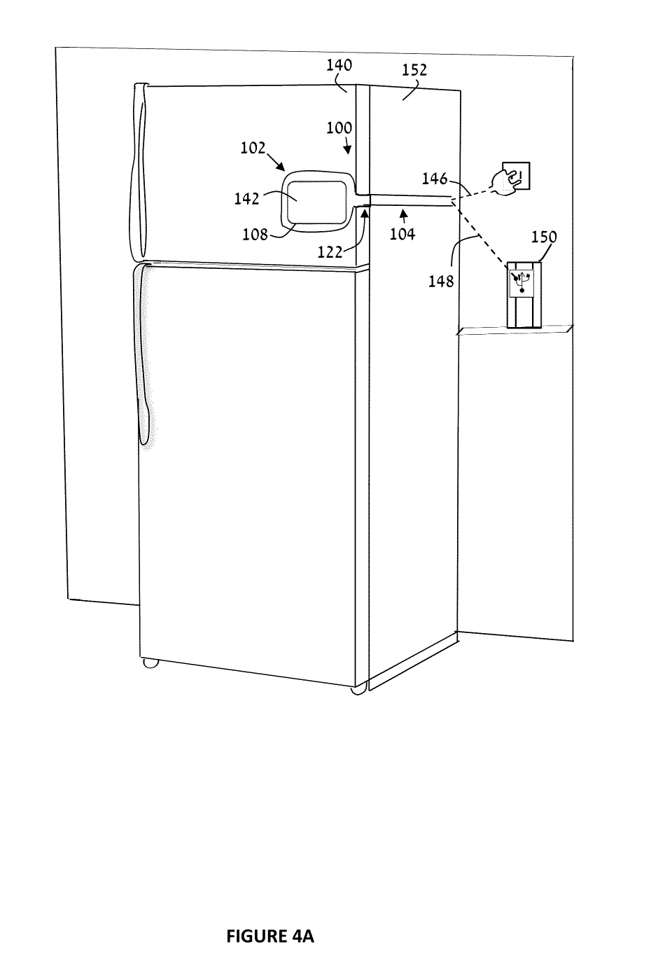

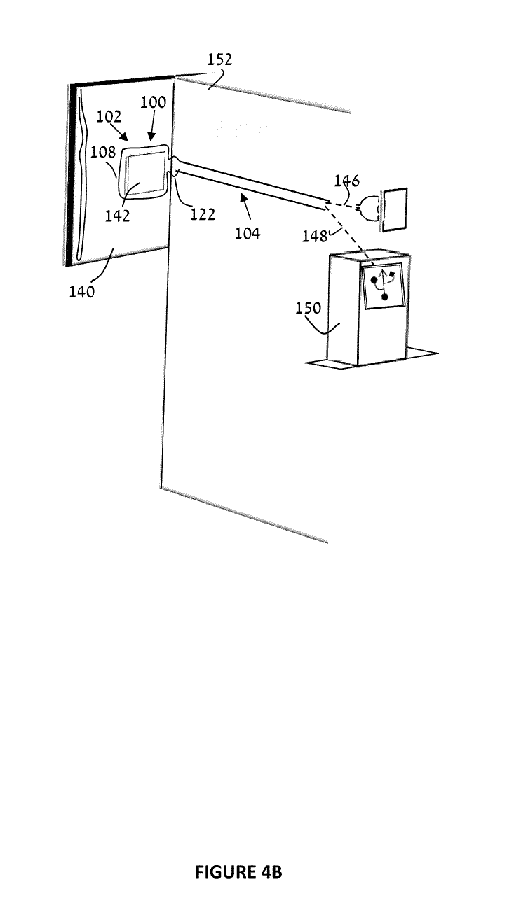

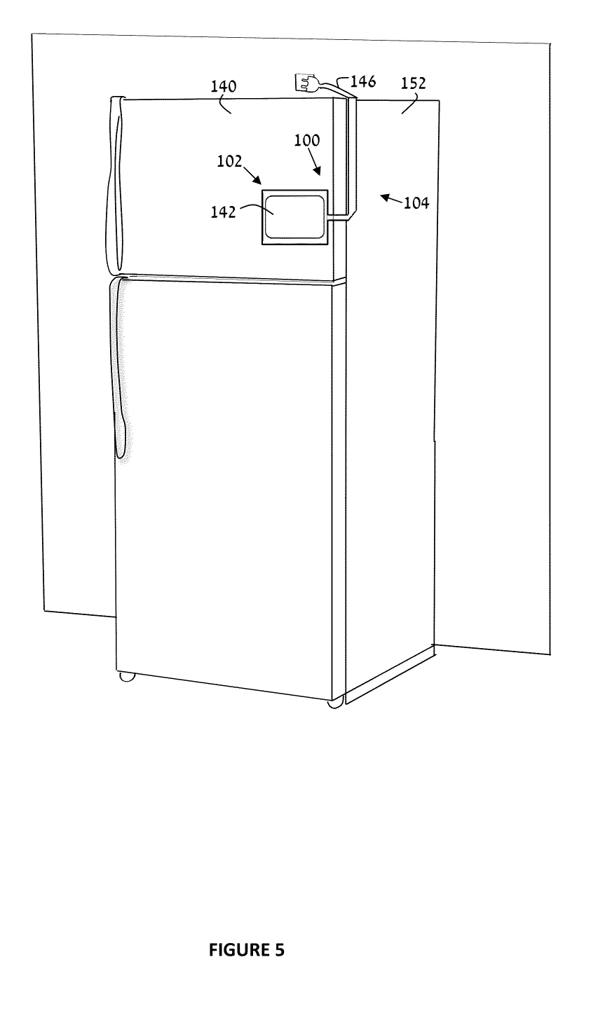

Reference is now made to FIGS. 4A and 4B, which are schematic illustrations of the device of FIGS. 1A and 1B, when mounted onto a hinged door according to an embodiment of the teachings herein, the door being in closed and open positions, respectively, and to FIG. 5A, which is a schematic illustrations of the device of FIGS. 1A and 1B, when mounted onto a hinged door according to another embodiment of the teachings herein.

As seen in FIGS. 4A and 4B, the body portion 102 of a device 100 according to the teachings herein, here shown as the device of FIGS. 1A and 1B, is mounted onto a vertical refrigerator door 140, by engagement of the body mounting mechanisms of body portion 102 (labeled in FIG. 1B by reference numerals 112) with the surface of the refrigerator door. A display 142 is disposed within body portion 102 on the refrigerator door, and is visible to a user via opening 108.

A power supply wire 146 and a USB connection cable 148 extend through the wire concealing portion 104, such that power supply wire 146 is connected to an electrical socket adjacent the refrigerator, and USB connection cable 148 connects display 142 to a computing device 150 associated therewith. In some embodiments, power may be supplied to the computing device form a power supplying USB socket, and the power supply wire 146 comprises a USB cable. Similarly, the power supply wire may be any wire for supplying power to the display 142, and may be connected to any suitable socket. It is appreciated that in some embodiments, display 142 forms part of a mobile or portable computing device, such as a tablet computer or smart mobile telephone. In such embodiments the wire concealing portion only conceals a power supply wire.

When the refrigerator door 140 is closed, as seen in FIG. 4A, flexible portion 122 of wire concealing portion 104 of the device 100 bends around the corner of refrigerator door 140, which is hingedly connected to a side wall 152 of the refrigerator. As such, most of the wire concealing portion extends along side wall 152 away from door 140 and is mounted thereon by engagement of the wire mounting mechanisms of wire concealing portion 104 (labeled in FIG. 1B by reference numeral 120) with the surface of the side wall. However, when the refrigerator door 140 is open, as seen in FIG. 4B, flexible portion 122, which does not include any wire mounting mechanisms, puckers and extends more distantly to the now aligned surfaces of door 140 and side wall 152 at the area of the hinge connecting the door and side wall, thereby allowing convenient opening of the door while protecting the concealed wires from the wear of constant bending and loosening.

Turning specifically to FIG. 5, it is seen that the device 100 is mounted in substantially the same way as shown in FIG. 4A, only that wire concealing portion 104, having bent around the corner between door 140 and wall 152, extends upwards along wall 152 toward a top surface of the refrigerator, for connection of the power supply wire 146 to a socket placed high up.

It is appreciated that though FIGS. 4A-5 illustrated the use of the device shown in FIGS. 1A and 1B, the same mounting technique would be used, and the same puckering of the wire concealing portion 104 would occur, when using the device of FIGS. 2A and 2B or the device of FIG. 3. Additionally, it is appreciated that refrigerator door 140 may be replaced with any other vertical surface, such as a cabinet door, a door to a room, and the like.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention. Section headings are used herein to ease understanding of the specification and should not be construed as necessarily limiting.

What is claimed is:

1. A device for mounting a display associated with a computing device onto a vertical surface, the device comprising:
a body portion including an opening enabling a user to view a display associated with a computing device;
at least one body mounting mechanism, functionally associated with said body portion, for mounting said body portion onto a surface;
a wire concealing portion, functionally associated with said body portion and accommodating at least one wire connected to said display, said wire concealing portion including at least one wire mounting mechanism; and
at least one flexible portion connecting said body portion to said wire concealing portion.

2. The device of claim 1, wherein said at least one flexible portion forms part of said wire concealing portion, and said at least one wire mounting mechanism is not located on said at least one flexible portion of said wire concealing portion.

3. The device of claim 1, wherein said opening is formed on a first surface of said body portion, and said at least one body mounting mechanism is attached to a second surface of said body portion, opposing said first surface.

4. The device of claim 1, wherein said body portion, said at least one flexible portion, and said wire concealing portion are integrally formed.

5. The device of claim 1, wherein said body portion and said wire concealing portion comprise two separate portions.

6. The device of claim 5, wherein said body portion and said wire concealing portion are connected by a connecting mechanism, said connecting mechanism comprising said at least one flexible portion.

7. The device of claim 1, wherein said at least one wire comprises a power cable providing power to said display.

8. The device of claim 1, wherein said at least one wire comprises a wire connecting said display to said computing device associated therewith.

9. The device of claim 1, wherein said display comprises a computing device.

10. The device of claim 1, wherein said at least one flexible portion includes at least one notch adapted to enable said at least one flexible portion to lie adjacent to a corner between said vertical surface and another surface.

11. The device of claim 1, wherein:
said vertical surface comprises a first vertical surface hingedly connected to a second vertical surface, such that in a first orientation said first and second surfaces are angled with respect to one another to form a corner and in a second orientation said first and second surfaces are aligned with one another; and
said body portion is adapted to be mounted onto said first surface, and said wire concealing portion is adapted to be mounted onto said second surface, and said at least one flexible portion is adapted to be mounted about said corner, such that:
when said first and second surfaces are in said first orientation, said flexible portion engages said first and second surfaces along said corner, and
when said first and second vertical surfaces are in said second orientation, said flexible portion disengages said first and second surfaces adjacent a hinge connecting said first and second surfaces.

12. The device of claim 11, wherein said first surface comprises a door and said second surface comprises a side surface hinged to said door, such that in said first orientation said door is closed, and in said second orientation said door is open.

13. The device of claim 11, wherein said flexible portion includes at least one notch adapted to enable said wire concealing portion to engage said corner.

14. The device of claim 1, wherein said body portion includes an insertion opening, separate from said opening, for inserting said display into said body portion.

15. A method of mounting a display associated with a computing device on a vertical surface, the method comprising:
providing a mounting device comprising a body portion, a wire concealing portion, and at least one flexible portion disposed therebetween, said mounting device including at least one body mounting mechanism and at least one wire mounting mechanism;
placing said display in said body portion of said mounting device, such that said display is visible through an opening in said body portion;
threading a wire associated with said display through said wire concealing portion; and
using at least one of said at least one body mounting mechanism and said at least one wire mounting mechanism, mounting said mounting device having said display and said wire disposed therein onto said vertical surface.

16. The method of claim 15, wherein:
said vertical surface comprises a first vertical surface hingedly connected to a second vertical surface, such that in a first orientation said first and second surfaces are angled with respect to one another to form a corner and in a second orientation said first and second surfaces are aligned with one another; and
said mounting device comprises mounting said body portion onto said first surface, and mounting said wire concealing portion onto said second surface, such that said at least one flexible portion extends about said corner.

17. The method of claim 16, wherein:
when said first and second surfaces are in said first orientation, said flexible portion engages said first and second surfaces along said corner; and
when said first and second vertical surfaces are in said second orientation, said flexible portion disengages said first and second surfaces adjacent a hinge connecting said first and second surfaces.

18. The device of claim 16 wherein said providing comprises providing said mounting device such that said flexible portion includes at least one notch, and said mounting comprises mounting said flexible portion such that said notch engages said corner.
